(19) United States
(12) Patent Application Publication
(10) Pub. No.: US 2015/0259228 A1
(43) Pub. Date: Sep. 17, 2015

(54) RESIDUAL DISINFECTION OF WATER

(71) Applicant: PROCLEANSE LLC, Buffalo Grove, IL (US)

(72) Inventors: Kevin S. Spittle, Vero Beach, FL (US); Michael Robeson, Loveland, CO (US)

(73) Assignee: PROCLEANSE LLC, Buffalo Grove, IL (US)

(21) Appl. No.: 14/431,916

(22) PCT Filed: Sep. 30, 2013
(86) PCT No.: PCT/US13/62549

§ 371 Date: Mar. 27, 2015

Related U.S. Application Data
(60) Provisional application No. 61/706,995, filed on Sep. 28, 2012.

(51) Int. Cl. C02F 1/50

(52) U.S. Cl. CPC C02F 1/505

(57) ABSTRACT

A water disinfecting system usable with an isolated water volume has a first concentration of a first metal and a second concentration of a second metal. The second metal being different from the first metal. The first and second metals each having an anodic index. The first metal having a higher anodic index than the second metal anodic index. The first metal and second metal form a galvanic coupling when placed into the isolated water volume.

### CROSS-REFERENCE TO RELATED APPLICATIONS

This application claims the benefit of U.S. provisional application Ser. No. 61/706,995 filed Sep. 28, 2012, which is incorporated herein by reference in its entirety.

### TECHNICAL FIELD

The present invention relates to residual disinfection of water.

### BACKGROUND

Water collected from certain otherwise protected storage locations and treatment centers may become subsequently contaminated while in transit to the household or while in the household prior to use. Frequently the source of this contamination is poor hygiene from hands contaminated with human feces. Hygiene may be an unavoidable problem in the developing world.

### SUMMARY

Embodiments of the present invention solve one or more problems of the prior art by providing, a water disinfecting system usable with an isolated water volume. In at least one embodiment, the water disinfecting system has a first concentration of a first metal and a second concentration of a second metal and is different from the first metal. The first and second metals each have an anodic index and the first metal has a higher anodic index than the second metal anodic index. The first metal and second metal form a galvanic coupling when placed into an isolated water volume.

In another embodiment, the water disinfecting system has a support made of a porous ceramic particles, with the support having an exterior surface and a first metal and a second metal covering at least a portion of the exterior surface of the porous ceramic particle support. The first metal has a first metal concentration and the second metal has a second metal concentration different from the first metal. The first and second metals each have an anodic index. The first metal has a higher anodic index than the second metal anodic index. The first metal and second metal form a galvanic coupling when placed into an isolated water volume.

In yet another embodiment, the water disinfecting system includes a water permeable container and a mixture of metals disposed within the container. The mixture of metals comprising a first concentration of a first metal and a second concentration of a second metal, different from the first metal. The first and second metals each have an anodic index with the first metal having a higher anodic index than the second metal anodic index. The first metal and second metal form a galvanic coupling when placed into an isolated water volume.

### BRIEF DESCRIPTION OF THE DRAWINGS

FIG. 1 shows a comparison in E. coli reading between a control water and a sample water as referenced in Example 2; and

FIG. 2 shows a comparison in fecal coliform reading between a control water and a sample water as referenced in Example 3.

### DETAILED DESCRIPTION

Reference will now be made in detail to compositions, embodiments, and methods of the present invention known to the inventors. However, it should be understood that disclosed embodiments are merely exemplary of the present invention which may be embodied in various and alternative forms. Therefore, specific details disclosed herein are not to be interpreted as limiting, rather merely as representative bases for teaching one skilled in the art to variously employ the present invention. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Except where expressly indicated, all numerical quantities in this description indicating amounts of material or conditions of reaction and/or use are to be understood as modified by the word “about” in describing the broadest scope of the present invention. It must also be noted that, as used in the specification and the appended claims, the singular form “a,” “an,” and “the” comprise plural referents unless the context clearly indicates otherwise. For example, reference to a component in the singular is intended to comprise a plurality of components.

The description of a group or class of materials as suitable for a given purpose in connection with one or more embodiments of the present invention implies that mixtures of any two or more of the members of the group or class are suitable. Description of constituents in chemical terms refers to the constituents at the time of addition to any combination specified in the description, and does not necessarily preclude chemical interactions among constituents of the mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

Throughout this application, where publications are referenced, the disclosures of these publications in their entireties are hereby incorporated by reference into this application to more fully describe the state of the art to which this invention pertains.

The following terms or phrases used herein have the exemplary meanings listed below in connection with at least one embodiment:

“Antimicrobial” refers to killing microorganisms or suppressing their multiplication or growth. The term “deactivation” may be used interchangeably with “antimicrobial”.

“Particles” as used herein refers to: (i) porous ceramic particles; and, (ii) inorganic non-ceramic particles which include one or more types of porous particles such as smectite clay, perlite, sand, vermiculite, zeolite, Fuller's earth, diatomaceous earth, shale, and combinations thereof.

“Anode” refers to the electrode of an electrolytic cell at which oxidation is the principal reaction.

“Cathode” refers to the negatively charged electrode. The cathode attracts cations or positive charge. The cathode is the source of electrons or an electron donor. It may accept positive charge. Because the cathode may generate electrons, which typically are the electrical species doing the actual movement, it may be said that cathodes generate charge or that current moves from the cathode to the anode.

“Galvanic couple” refers to dissimilar substances (as metals) capable of acting together as an electric source when brought in contact with an electrolyte; the corrosive cell formed when two different metals are separated by an electrolyte, or the corrosion produced by this effect. The term “couple” of galvanic couple does not limit to just two metals capable of acting together as an electric source when brought in contact with an electrolyte. A galvanic couple may refer to two metals, three metals, four metals, five metals, and so on.

“Galvanic current” refers to the electric current between metals or conductive non-metals in a galvanic couple.

“Galvanic series” refers to a list of metals and alloys arranged according to their relative corrosion potentials in a given environment.

“Ion” refers to an atom or group of atoms that has gained or lost one or more outer electrons and thus carries an electric charge. A Positive ions, or cations, are deficient in outer electrons. Negative ions, or anions, have an excess of outer electrons.

“Ion pair” refers to consists of a positive ion and a negative ion temporarily bonded together by the electrostatic force of attraction between them. Ion pairs occur in concentrated solutions of electrolytes (substances that conduct electricity when dissolved or molten). Ion-pairs are formed when a cation and anion come together. Aⁿ⁺+B^{m-}⇄AB^{(n-m)+}

“Ionization” refers to the process in which atoms gain or lose electrons; sometimes used as synonymous with dissociation, the separation of molecules into charged ions in solution.

“Water”, “raw water”, “isolated water”, or “waste water” refers to a water source that may contain various types of organic matter, sediment, and/or disease-causing pathogens. Non-limiting examples of the disease-causing pathogens include bacteria, viruses, protozoa, and helminthes (parasitic worms).

The following references are incorporated in their entirety: (i) Handbook of Corrosion Engineering, McGraw-Hill, publication Date: 2000, ISBN 007-076516-2; (ii) Evaluating household water treatment options: Health-based targets and microbiological performance specifications, World Health Organization, publication date 2011, ISBN 978 92 4 154822 9; (iii) STP442A Manual on Water, Fourth Edition, Hamilton C., 1978, ISBN-EB: 978-0-8031-6914-2; (iv) ASTM D1129-13 Standard Terminology Relating to Water; (v) ASTM D6734-01(2009) Standard Test Method for Low Levels of Coliphages in Water; and, (vi) ASTM E2756-10 Standard Terminology Relating to Antimicrobial and Antiviral Agents.

The present invention, in one or more embodiments, is advantageous in providing residual disinfection of water that may be susceptible to downstream contamination, including contamination incurred during transit to the household or while in storage prior to use. It is residual disinfection in the sense that otherwise drinkable water may be subsequently contaminated during transit and the water is to remain drinkable via the residual disinfection method described herein.

The water may be collected from a protected deep well or may have been previously disinfected but subsequently contaminated due to poor hygiene. The residual disinfection may be useful for continuously safeguarding the water from any potential downstream contamination. The residual disinfection may be useful for disinfecting a water source produced from any water treatment plant wherein the water source may be subject to contamination during transit. In these situations, it is possible that the water may be packaged in bulk and may not have been sealed sufficiently enough to fend off secondary contaminations. The water source may also be water in a storage tank or cistern positioned for human consumption.

One benefit of the present invention as can be seen from the example(s) described herein is that the water as processed contains cations of metals, such as Ag, Cu and Zn, which provide a level of disinfection. This benefit can be observed in direct comparison to a deionized water control source that has been contaminated with the same level of coliforms, whether it is total coliform, E. coli or fecal coliforms.

In one embodiment, the residual disinfection may be carried out by imparting to an isolated volume of water a first concentration of a first metal and a second concentration of a second metal, the second metal having an anodic index different from an anodic index of the first metal. The isolated volume of water is drinkable at the time of its collection, however, is open to environment and hence susceptible to subsequent contamination. Non-limiting examples of the isolated volume of water include water collected from a protected well or water produced from a water treatment facility.

The present invention, in one or more embodiments, takes beneficial use of the galvanic coupling between dissimilar metals within the context of residual disinfection of water. Dissimilar metals and alloys have different electrode potentials. When two or more dissimilar metals come into contact in an electrolyte, a galvanic couple is set up, in which one metal acts as an anode and the other as a cathode. The potential difference between the dissimilar metals causes the anode metal to dissolve into the electrolyte and to form its corresponding ionic form.

Metals can be classified into a galvanic series representing the electrical potential they develop in a given electrolyte against a standard reference electrode, for example gold. See Table 1. The relative position of two metals on such a series gives a good indication of which metal is more likely to corrode more quickly. However, other factors such as water aeration and flow rate can influence the rate of the process markedly. The galvanic series (or electropotential series) determines the nobility of metals and semi-metals. When two metals are submerged in an electrolyte, while electrically connected, the less noble (base) will experience galvanic corrosion. The rate of corrosion is determined by the electrolyte and the difference in nobility. The difference can be measured as a difference in voltage potential.

TABLE 1

| | Index |
|---|---|
| Metal Most Cathodic | (V) |
| Gold, solid and plated, Gold-platinum alloy | 0 |
| Rhodium plated on silver-plated copper | −0.05 |
| Stainless Steel 300 series | −0.1 |
| Silver, solid or plated; monel metal. High nickel-copper alloys | −0.15 |
| Nickel, solid or plated, titanium an s alloys, Monel | −0.3 |
| Copper, solid or plated; low brasses or bronzes; silver solder; | −0.35 |
| German silvery high copper-nickel alloys; nickel-chromium alloys | |
| Brass and bronzes | −0.4 |
| High brasses and bronzes | −0.45 |
| 18% chromium type corrosion-resistant steels | −0.5 |
| Chromium plated; tin plated; 12% chromium type corrosion- | −0.6 |
| resistant steels | |
| Tin-plate; tin-lead solder | −0.65 |
| Lead, solid or plated; high lead alloys | −0.7 |
| 2000 series wrought aluminum | −0.75 |
| Iron, wrought, gray or malleable, plain carbon and low alloy steels | −0.85 |
| Aluminum, wrought alloys other than 2000 series aluminum, cast | −0.9 |
| alloys of the silicon type | |
| Aluminum, cast alloys other than silicon type, cadmium, plated and | −0.95 |
| chromate | |
| Hot-dip-zinc plate; galvanized steel | −1.2 |
| Zinc, wrought; zinc-base die-casting alloys; zinc plated | −1.25 |
| Magnesium & magnesium-base alloys, cast or wrought | −1.75 |
| Beryllium | −1.85 |

Most Anodic

The most noble metals act as the cathode and the other metal as the anode and water as the electrolyte. Referring to Table 1, Ag −0.15 Volt paired with Cu −0.35 Volts, results in an electrochemical voltage produced could be as high as 0.20 volts or 200 millivolts. In another example, Cu −0.35 paired with Zn −1.25 results in a maximum voltage is 0.9 volts or 900 millivolts. In one embodiment, the anodic index of the first metal and the second metal has a maximal difference, thus, resulting in a higher voltage and exchange of ions for water disinfection.

A first metal having a relatively higher anodic index may pair up with a second metal having a relatively lower anodic index to form a galvanic couple. At either of the anode and the cathode, one or more metals or metal alloys may be employed. The first metal functions as a cathode and the second metal functions an anode in the galvanic couple. Ag and Au are each a non-limiting example of the first metal that may be included at the cathode side. Cu and Zn are each a non-limiting example of the second metal that may be included at the anode side. Non-limiting examples of the ionic pair include Ag—Cu, Ag—Zn, and Ag—Cu—Zn. This exchange of ions using water as the electrolyte provides an effective disinfectant for bacterial pathogens as well as viruses. Without wanting to be limited to any particular theory, it is believed that metal ions carrying positive charges are attracted to pathogenic organisms carrying negative surface charges and then the resultant electric coupling causes the organisms cell wall to be damaged and subsequently deactivates the organism. In this connection, it can be said that the present invention in one or more embodiments is advantageous in providing a long lasting disinfectant unlike chlorine that loses activity over time as choline may combine with organic compounds in the water.

At least one of the first and second metals may be copper or a copper alloy. Non-limiting examples of the copper alloy include alloys of copper with aluminum, copper with zinc, copper with silicon, and copper with nickel.

At least one of the first and second metals may be zinc or a zinc alloy. Non-limiting examples of the zinc alloy include alloys of zinc with copper, zinc with aluminum, zinc with magnesium, zinc with iron, zinc with cobalt, and zinc with nickel.

At least one of the first and second metals may be silver or a silver alloy. Non-limiting examples of the silver alloy include silver with copper, silver with gold, and silver with platinum. In certain instances, the first metal may be copper and the second metal may be zinc.

To impart a higher efficiency of oxidation of the anodic metals, copper sulfate may be present which increases the surface oxidation of the first and second metals. The copper sulfate may be present in an amount less than 1% of the total metal weight, in another embodiment, the copper sulfate may be present in a range from 0.2 to 0.5%, 0.2 to 1%, and 0.5 to 1% of the total metal weight.

The term “first metal” and “second metal” are employed to indicate one or more embodiments wherein more than one type of metal may be used. In one embodiment, for example, the metals may include a first metal, a second metal, and a third metal. In yet another embodiment, the metals may include a first metal, a second metal, a third metal, and a fourth metal. In yet another embodiment, the metals may include a first metal, a second metal, a third metal, a fourth metal, and a fifth metal. In another variation, the number of metals that may be employed to form a galvanic couple is at least two metals. In another embodiment, the method may further include the step of imparting to the volume of water a third concentration of a third metal having an anodic index different from the ionic index of the first metal and the ionic index of the second metal. That is, the first metal serves as the cathode to the second metal, while the second metal serves as the anode to the first metal. However, the second metal serves as the cathode to the third metal, while the third metal serves as the anode to the second metal. The first, second and third metals may be copper, zinc and silver, respectively.

Any suitable metals that exhibit antimicrobial activities and are capable of creating a galvanic coupling may be used. For instance, the metals and grouping may include, but not limited to a three metal grouping or deletion of one metal from each group to make a two metal pair: Titanium to Copper to Zinc; Stainless Steel to Copper to Zinc; Titanium to Bronze to Zinc; Stainless Steel to Bronze to Zinc; Titanium to Brass to Zinc; Stainless Steel to Brass to Zinc; Titanium to Copper to Aluminum; Stainless Steel to Copper to Aluminum; Titanium to Bronze to Aluminum; Stainless Steel to Bronze to Aluminum; Titanium to Brass to Aluminum; Stainless Steel to Brass to Aluminum. In addition, copper may be replaced with either bronze or brass. It is also understood that the metal position in the group may represent a first metal, a second metal, and a third metal. For example, Titanium to Copper to Zinc, where Titanium is the first metal, Copper is the second metal, and Zinc is the third metal. A deletion of one of the metals from the three metal groupings to make a two metal pair may arbitrarily renumber which metal is the first and second metal. Further in referring to Table 2, metal pairings may be achieved through selecting metals having desirable antimicrobial activities and/or the ability to exchange ions.

TABLE 2
Galvanic series of some commercial metals and alloys in seawater.

| | |
|---|---|
| | Most cathodic, noble, or resistant to corrosion |
| group 1 | platinum |
| | gold |
| | graphite |
| | titanium |
| | silver |
| | / Chlorimet 3 |
| | \ Hastelloy C |
| group 2 | / 18-8 Mo stainless steel (passive) |
| | \| 18-8 stainless steel (passive) |
| | \ Chromium steel >11% Cr (passive) |
| | / Inconel (passive) |
| | \ Nickel (passive) |
| | / Silver solder |
| | \| Monel |
| | \| Bronzes |
| | \| Copper |
| | \ Brasses |
| group 3 | / Chlorimet 2 |
| | \ Hastelloy B |
| | / Inconel (active) |
| | \ Nickel (active) |
| | Tin |
| | Lead |
| | Lead-tin solders |
| | / 18-8 Mo stainless steel (active) |
| | \ 18-8 stainless steel (active) |
| | Ni-resist |
| | Chromium steel >11% Cr (active) |
| group 4 | / Cast iron |
| | \ Steel or iron |
| | 2024 aluminum |
| | Cadmium |
| | Commercially pure aluminum |
| | Zinc |
| | Magnesium and its alloys |
| | Most anodic or easy to corrode |

A non-limiting frame work in selecting a metal pair or pairs to form a galvanic coupling for disinfection include: (i) the first metal is highly cathodic; (ii) the first metal is a noble metal; (iii) the first metal is not corrosive; and/or (iv) the second metal has some historical antimicrobial properties. Thus, the selection criterion may include metal(s) selected should have antimicrobial activities and the metal(s) ability to exchange ions through electrochemical process through anodic volt difference. Thus, in referring to Table 2, a Group 1 metal or Group 2 metal could be paired with a Group 4 metal. In the alternative, in a system having three distinct metals, a Group 1 metal may be paired with a Group 3 metal and a Group 4 metal.

Another consideration in metal pairing is the anode capacity. Anode capacity is an indication of how much metal is consumed as current flows over time. For example, the value for zinc in seawater is 780 Ah/kg but aluminum is 2000 Ah/kg, which means that, in theory, aluminum can produce much more current than zinc before being depleted and this is one of the factors to consider when choosing a particular metal.

Regulating the physical distance between the first metal and second metal and other metals if present may influence the formation of a galvanic couple and the formation of ions in the water. The closer the first metal to the second metal is anticipated to have a higher efficiency of forming a galvanic couple. In one embodiment, the first metal and the second metals are in physical contact with each other. Describing the positional relationship between a first metal particle and a second metal particle and how that relationship influences the formation of a galvanic couple and formation of ions in the water may be achieved through: (1) describing the distance and percentage, by particles, separating the first and second metal particles; and (2) describing the relationship by volume separating the first and second metals. In regards to (1) describing the distance and percentage, by particles, may have at least three variables to consider: (i) distance separating the first metal particles and second metal particles; (ii) the percent of first metal particles within the defined distance to the second metal particles; (iii) the percent of second metal particles within the defined distance to the first metal particles. For example, in one embodiment 50% of the first metal particles are within 1 mm of 50% of the second metal particles. In regards to the distance variable (i), the first metal and the second metal have an average physical distance less than or equal to 3 mm. In another variation, the physical distance of the first metal and the second metal are less than or equal to 1 mm, 0.5 mm, 0.25 mm, 0.1 mm, 500 μm, 250 μm, 100 μm, 50 μm, and 25 μm. In regards to the (ii) variable, the percent of first metal particles within the defined distance to the second metal particles: the 35 to 100% of the first metal particles within a distance and a percentage of the second metal particles, 50 to 100% of the first metal particles within a distance and a percentage of the second metal particles, 75 to 100% of the first metal particles within a distance and a percentage of the second metal particles, or 50 to 85% of the first metal particles within a distance and a percentage of the second metal particles. In regards to (iii) variable, the percent of second metal particles within the defined distance to the first metal particles: the 35 to 100% of the second metal particles within a distance and a percentage of the first metal particles, 50 to 100% of the second metal particles within a distance and a percentage of the first metal particles, 75 to 100% of the second metal particles within a distance and a percentage of the first metal particles, or 50 to 85% of the second metal particles within a distance and a percentage of the first metal particles. Describing the distance and percentage, by particles, is scalable, to embodiments having at least a third metal. For example, distance variables (iv and v) may be included for the (iv) distance from the second metal and the distance from the third metal and (v) the distance from the first metal and the third metal. Likewise, variables for the percentage of particles within the distance range for the second metal and third metal, and the third metal and the first metal.

In regards to (2) describing the relationship by volume separating the first and second metal, and other metals if present, in the formation of a galvanic couple and the formation of ions in the water is through. In another embodiment, the total weight of the first metal is located in a first metal volume. The total weight of the second metal is located in a second metal volume. The first metal volume has a % of the first metal total weight within a certain distance of the second metal volume. For example, in another embodiment, the first and second metals are mixed and the first and second metals are equally distributed in the water volume for the first and second metals. This water volume of the first and second metals may be a fraction of the total water volume. Thus, the ratio of the first metal volume to the second metal volume is 1:1±25%; the position of the first metal volume and second metal volume overlap at least 60%.

The water disinfecting system may have a measurable voltage in the water that is determinative of the efficacy of its disinfecting characteristics. In one embodiment, the water disinfecting system may have a range of 100 to 2000 millivolts. In another variation, the water disinfecting system may have a range of 600 to 1200 millivolts, 500 to 1650 millivolts, and 600 to 2000 millivolts. Determination of the voltage within the water disinfecting system may be determined through the following testing procedures: 1) ASTM D1498-08 Standard Test Method for Oxidation-Reduction Potential of Water. 2) Alternatively, determination of the voltage within the water disinfecting system may be determined through the following testing procedure: placing 200 grams of the metal mix in a 500 ml beaker. The beaker is filled with 400 ml of DI water. A first electrode from a voltmeter is placed in the metals. A second electrode is placed approximately 1″ from the surface of the metals in the water. The voltage is measured.

The amount of metal particles supplied to the water may be correlated to potential disinfection and deactivation characteristics. That is less total metal is needed with smaller water volumes. Moreover, increasing the amount of metal weight may increase the volume of water which may be disinfected. For example, 29 grams of total metals may be sufficient to treat 4 liters and up to 190 liters of contaminated water. However, the cost of metals, including but not limited to noble metals, may limit the total metal supplied. In one embodiment, the total metal weight is from 0.5 grams to 1,000 grams.

According to one or more embodiments of the method, the resultant water is substantially free of metal salts such as copper salts. In this connection, the resultant water may be substantially free of one or more of the following negative ions: [Cl]⁻, [SO₄]²⁻, and/or [PO₄]³⁻. This is in direct contrast to the water obtainable from conventional treatment where metal salts are used to disinfect. Because the water treatment method according to one or more embodiments of the present invention does not necessarily use metal salts, the resulting water as process does not necessarily have to include these negative ions, which if incidentally present, are of no significant value.

According to one or more embodiments of the present invention, the residual disinfection may be carried out in a way substantially free of external energy input, such as electrical or metal energy external to the volume of water. In this connection, the residual disinfection may be materialized by dipping into the water a sock of metals and the sock of metals may be pulled out of the water once desirable disinfection is realized.

The typical home storage tank is treated by dosing with chlorine once a week, once a month if at all. The chlorine treatment may be troublesome and time-consuming, not to mention potential byproduct toxicities due to chlorine treatment. The “dipping and pulling” feature of the residual disinfection described herein in relation to embodiments of the present invention assures that the water quality be safeguarded with requisite time and labor efficiency. In particular, the sock of ionizable metals may be placed in the water tank and simply left alone. This can be how various combinations of ionizable metals are introduced, placed in a tank for a given period of time, for instance, in months or years, and then replaced as needed. The replacement frequency would be based on the quantity of water processed and utilized by the home and or business.

Ionizable metals such as the first and second metals may be included in a sock, a pouch or container to be placed in the tank to provide this disinfectant capability for an extended period of time. The sock of metals may be a removable container including a first weight of the first metal and a second weight of the second metal. The sock of metals may be placed in the isolated volume of water and may contact only a portion of the isolated volume water. In certain instances, a stirrer driven by man power or electrical power may be implemented to facilitate metal ion distribution within the entire volume of water from the sock. However, the use of the stirrer is optional and may not be necessary.

The sock may be configured detachable for easy access and removal. A string and/or a hook may be attached to the sock such that the sock may be attached to and detached from the container in which the water to be treated is stored.

The sock for holding the metals can be of any suitable material that is permeable to water and ionized metals. Non-limiting examples of the material for forming the sock include natural fibers such as cotton, silk and leather, and synthetic fibers such as polymers and plastics. In certain instances, the use of organic materials may be limited to be of no more than 5 percent, 4 percent, 3 percent, 2 percent, 1 percent or 0.5 percent by weight of the total dry weight of the sock. Without wanting to be limited to any particular theory, it is believed that breakdown byproducts of the organic materials may feed the formation of various heterotrophic biofilms.

The sock can be of any suitable dimensions, dependent upon the particular treatment application at hand. Several considerations may be employed in determining the dimensions of the sock. For instance, the considerations may include the amount of water to be treated, the width-to-depth aspect ratio of the container within which the water is stored, and the type of metals to be included in the sock.

In certain instances, the sock is provided with a diameter of no greater than 5 inches, 4 inches, 3 inches or 2 inches. As the sock may have any suitable cross-sectional shape, the term “diameter” may refer to the circumference of the cross-sectional shape divided by the value π. In certain particular instances, the sock is provided with a diameter of 0.25 to 1.75 inches, 0.5 to 1.5 inches, or 0.75 to 1.25 inches. Without wanting to be limited to any particular theory, it is believed that the sock with this diameter dimension can keep the metals in close contact with each other so as to effectuate sufficient ion exchange.

Additionally, the sock may further include one or more supplement to effect supplemental effects other than disinfection of the water. Non-limiting examples of the supplement include limestone to vary pH, iron oxide to adsorb arsenic, and bone char to adsorb fluoride. In one embodiment, the total supplements represent 0.5-50% of the total metal weight. In another variation, the supplements represent 0.5-25% or 0.5-5% of the total metal weight. Optionally, the sock may be made to include perforations. The perforations can be configured such that metal leakage through the sock may be reduced or prevented, while the exchange of metal ions for disinfection purposes is largely retained.

It is noted that relatively large and super large water tanks may be used. In these instances, multiple socks containing the ionizable metals may be used for each of these tanks and may be disposed in various locations within the tank to provide a relatively more distributed coverage for the residual disinfection treatment. Of course, socks in larger dimensions may be used to the extent that the ionizable metals contained within the sock are in close enough proximity with each other to provide the level of contact needed to deliver the residual disinfection.

Alternatively, two or more ionizable metals may be melted together to form a metal blend, optionally in the form of a bar or wire. The bar or wire of the metal blend may be directly placed into the tank of water to be treated or may be placed within a sock described herein elsewhere prior to its contact with the water. Without wanting to be limited to any particular theory, it is believed that the ionizable metals are in relatively closer contact with each other in the bar or wire of the metal blend and would allow for relatively more uniform delivery of the ionized metals into the water.

The metal blend may be formed into a layer or a film covering at least a portion of the exterior surface of a support. The layer or the film may cover 35-100% of the exterior surface of the support. The support may be formed of one or more inert and inexpensive material in any suitable form such as a bar, a ball or a plurality of particles in any suitable geometrical shapes and forms. A non-limiting example of the particles includes inorganic particles independently selected from the group consisting of porous ceramic particles, smectite clay, perlite, vermiculite, zeolite, Fuller's earth, diatomaceous earth zeolite, and combinations thereof. This configuration may be beneficial in providing relatively greater surface area and hence surface contact between the ionizable metals and the water.

To further increase disinfection and purification of waste water, loose particles may be included to filter and/or increase the surface area for interaction and chemical reactions. Suitable porous particles include those commercially available as Profile Porous Ceramic particles by Profile Products, LLC of Buffalo Grove, Ill. These porous ceramic particles are clay-based montmorillonite particles, optionally mined from Blue Mountain, Mo. (MS), and fired to high temperatures such as 1000° F. to make a porous ceramic particle. In one embodiment, the porous ceramic particles are constituted of the following elements, 42% illite±15% by dry weight, 39% quartz±15% by dry weight, and 19% opal±15% by dry weight as determined by X-ray diffraction.

In one or more embodiments, the particles are referred to as a mesh screen size. The standard used herein is the Tyler mesh size. Tyler mesh size is the number of openings per (linear) inch of mesh. Particles are sometimes described as having a certain mesh size (e.g. 5 mesh porous ceramic particle). Particles may be referred to a size range from the percentage of particles that pass through a mesh screen and the percentage of particles that are retained on a mesh screen. This particular designation will indicate that a particle will pass through some specific mesh (that is, have a maximum size; larger pieces will not fit through this mesh) but will be retained by some specific tighter mesh (that is, a minimum size; pieces smaller than this will have passed through the mesh). This type of description establishes a range of particle sizes. For example, a “5×30”: particles pass no less than 95 percent on a number #5 sieve and retain no less than 95 percent on a number #30 sieve are alternatively termed “5×30” particles.

In certain instances, the porous ceramic particles pass no less than 95 percent on a number #5 sieve and retain no less than 95 percent on a number #30 sieve. These particles are alternatively termed “5×30” particles. In certain other instances, the porous ceramic particles pass no less than 95 percent on a number #24 sieve and retain no less than 95 percent on a number #48 sieve. These particles are alternatively termed “24×48” particles. In yet other instances, the porous ceramic particles pass no less than 95 percent on a number #10 sieve and retain no less than 95 percent on a number #20 sieve. These particles are alternatively termed “10×50” particles. In yet other instances, the porous ceramic particles pass no less than 95 percent on a number ½″ sieve and retain no less than 95 percent on a number #6 sieve. These particles are alternatively termed “½”×6 particles.

The porous ceramic particles have a size range of at least 95 percent of the porous ceramic particles will pass through about 12,700 micron screen and at least 95 percent will not pass thru about 51 micron screen. Moreover in another embodiment the porous ceramic particles have a size range of at least 95 percent of the porous ceramic particles will pass through about 10,000 micron screen and at least 95 percent will not pass thru about 150 micron screen, the porous ceramic particles have a size range of at least 95 percent of the porous ceramic particles will pass through about 7,500 micron screen and at least 95 percent will not pass thru about 200 micron screen, the porous ceramic particles have a size range of at least 95 percent of the porous ceramic particles will pass through about 4,000 micron screen and at least 95 percent will not pass thru about 51 micron screen, and the porous ceramic particles have a size range of at least 95 percent of the porous ceramic particles will pass through about 2,000 micron screen and at least 95 percent will not pass thru about 51 micron screen. In yet another embodiment, the porous ceramic particles have a size range of at least 95 percent of the porous ceramic particles will pass through about 20,000 micron screen and at least 95 percent will not pass thru about 20 micron screen, the porous ceramic particles have a size range of at least 95 percent of the porous ceramic particles will pass through about 15,000 micron screen and at least 95 percent will not pass thru about 20 micron screen, the porous ceramic particles have a size range of at least 95 percent of the porous ceramic particles will pass through about 10,000 micron screen and at least 95 percent will not pass thru about 20 micron screen, the porous ceramic particles have a size range of at least 95 percent of the porous ceramic particles will pass through about 5,000 micron screen and at least 95 percent will not pass thru about 20 micron screen, the porous ceramic particles have a size range of at least 95 percent of the porous ceramic particles will pass through about 2,000 micron screen and at least 95 percent will not pass thru about 20 micron screen, the porous ceramic particles have a size range of at least 95 percent of the porous ceramic particles will pass through about 20,000 micron screen and at least 95 percent will not pass thru about 75 micron screen, and the porous ceramic particles have a size range of at least 95 percent of the porous ceramic particles will pass through about 20,000 micron screen and at least 95 percent will not pass thru about 150 micron screen.

Non-limiting examples for the 5×30, 10×50, 24×48, and ½″×6 porous ceramic particles include porous ceramic particles under the trade name of “MVP”, “Field and Fairway”, “Greens Grade”, and “Orchid Mix”, respectively, available from Profile Products, LLC of Buffalo Grove, Ill. Non-limiting particle distribution values for these particles are tabulated in Tables 3A and 3B below.

In certain instances, the porous ceramic particles pass no less than 95 percent on a number #5 sieve and retain no less than 95 percent on a number #30 sieve. These particles are alternatively termed “5×30” particles. In certain other instances, the porous ceramic particles pass no less than 95 percent on a number #24 sieve and retain no less than 95 percent on a number #48 sieve. These particles are alternatively termed “24×48” particles. In yet other instances, the porous ceramic particles pass no less than 95 percent on a number #10 sieve and retain no less than 95 percent on a number #20 sieve. These particles are alternatively termed “10×20” particles. In yet other instances, the porous ceramic particles pass no less than 95 percent on a number ½″ sieve and retain no less than 95 percent on a number #6 sieve. These particles are alternatively termed “½”×6 particles.

TABLE 3A

| | Percentages of particles collected | | | | | |
|---|---|---|---|---|---|---|
| | on sieves in millimeters (mm) | | | | | |
| | 2 mm | 1 mm | 0.5 mm | 0.25 mm | 0.15 mm | 0.05 mm |
| MVP | 55-63 | 35-43 | 1.5-2.5 | 0.1-0.5 | 0.05-0.2 | 0.05-0.2 |
| 5 × 30 | | | | | | |
| Pro League | 18-24 | 67-73 | 5.0-7.0 | 0.2-0.6 | 0.1-0.3 | 0.05-0.2 |
| Field & Fairway | less than | 32-38 | 41-47 | 17-23 | 0.05-0.2 | 0.05-0.2 |
| 10 × 20 | 0.5 | | | | | |
| Greens Grade | less than | 0.05-0.2 | 52-67 | 37-44 | 0.05-0.4 | 0.05-0.4 |
| 24 × 48 | 0.5 | | | | | |
| Quick Dry 60 × | less than | less than | 1-3 | 17-23 | 30-40 | 30-40 |
| 635 | 0.05 | 0.05 | | | | |

It also noted that Quick Dry 60×635 has less than 0.05% of the particles collected on a 0.02 mm sieve.

TABLE 3B

| | Percentages of particles collected on sieves | | | | | |
|---|---|---|---|---|---|---|
| | in millimeters (mm) | | | | | |
| | 9.5 mm | 8.0 mm | 6.3 mm | 3.4 mm | 1.7 mm | <1.7 mm |
| Orchid Mix | 5-20 | 12-27 | 25-33 | 25-45 | 0.5-3 | 2-7 |
| ½″ × 6 | | | | | | |

Average pore size of the porous particles can be of any suitable values. In certain instances, average pore size range from 0.1 to 20 microns, 0.5 to 18 microns, 1.0 to 16 microns, 2.0 to 14 microns, 2.5 to 12 microns, 3.0 to 10 microns, 3.5 to 8 microns, 0.5 to 2.5 microns, 2.5 to 5.0 microns, 5.0 to 7.5 microns, 7.5 to 10.0 microns, 10.0 to 12.5 microns, 12.5 to 15.0 microns, 15.0 to 17.5 microns, or 17.5 to 20.0 microns in diameter.

The cation exchange capacity (CEC) is the number of positive charges that an inorganic particle (inorganic non-ceramic particles and porous ceramic particles) can contain. It is usually described as the amount of equivalents necessary to fill the inorganic particle capacity. (CEC) is the maximum quantity of total cations that a particle is capable of holding, at a given pH value, available for exchange with the media solution. CEC is used as a measure of the potential to deliver cations to deactivate microorganisms and the capacity to purify waste water from pathogenic microorganism contamination. It is expressed as milli-equivalent of hydrogen per 100 g of dry particles (meq/100 g). Thus, higher the CEC value of the inorganic particle, the higher potential capacity of the water purification device to effectively reduce the log amount of pathogenic microorganisms in the waste water. Without wanting to be limited to any particular theory, it is believed that the metals oxidize and exchange cations of silver, copper and zinc with the water on the cation exchange sites within the porous ceramic particles. It is believed that about 120 to 150 million particles per device can be charged with metal ions that, when contacted by the microorganisms moving through, exchange with the cell membrane and deactivate the passing through organisms.

To further increase the formation of ions in the waste water and/or galvanic couple, the porous ceramic particles may be at least partially coated with the first metal and the second metal. In another variation, the porous ceramic particles may be coated with a third metal, or a third metal and fourth metal, and so on. The porous ceramic particles have an inherent cation exchange capacity which allows for adsorption of the metal particles. Mixing may be used to associate the metal particles with the porous ceramic particles. Further, association of the metal particles with the porous ceramic may be accomplished through known methods in the industry, including but not limited to: slurry re-suspension followed by heating, or melting the metals onto the porous ceramic particles. The porous ceramic particles have an external surface area which may not include the pores. The porous ceramic particles' external surface area may be coated with metal particles at 25-100% of the porous ceramic particles' external surface area, 25-50%, 50-100%, 75-100%, and 90-100% of the porous ceramic particles' external surface area. Moreover, the metal particles may associate with the porous ceramic particles within the pores of the porous ceramic particles. The metal particles may represent 25-900% of the porous ceramic particles weight. Further, the porous ceramic particles have a total-external/internal-surface-area which includes the external surface area and the internal surface area of the pores. In another embodiment, the internal volume of the pores may be partial coated with metal particles, where at least 10% of the total-external/internal-surface-area contains metal particles.

Because the residual disinfection is carried out via the galvanic coupling described herein, materials such as chlorine and chloramine otherwise used in the art may be avoided. In this connection, chlorine and/or chloramines, if accidentally present, are included in a level below the levels otherwise used in the art for disinfection, for instance, at a level no greater than 4 ppm (parts per million), 1 ppm, 0.5 ppm, 0.1 ppm, 0.05 ppm, or 0.01 ppm.

Chlorine in particular poses special health concerns as chlorine may react with organic material in water and hence produce disinfection byproducts in the distribution system. Some of these disinfection byproducts such as the trihalomethanes (THMs) and haloacetic acids (HAAs) may have adverse health effects at high levels.

Chloramines, like chlorine, are toxic to fish and amphibians even at levels otherwise allowable for drinking water. Chloramines in particular do not rapidly dissipate on standing. Neither do chloramines dissipate by boiling. Fish owners must neutralize or remove chloramines from water used in aquariums or ponds.

Because the galvanic coupling metals may be relatively more stable and longer lasting than free chlorine or chloramine, the present invention in one or more embodiments provides better protection against bacterial re-growth in systems with large storage tanks and dead-end water mains. Moreover, and because the galvanic coupling metals do not tend to react with organic compounds in water, many systems will experience less incidence of taste and odor complaints.

The drinkable water produced according to one or more embodiments may refer to a water product in which total coliforms are no greater than 10 CFU (colony forming units) per 100 mls of water. Coliforms may naturally present in the environment as well as feces. Fecal coliforms and E. coli may only come from human and animal fecal waste.

The drinkable water produced according to one or more embodiments may refer to a water product in which chlorite is no greater than 1.0 ppm, 0.5 ppm, 0.1 ppm, 0.05 ppm, or 0.01 ppm. Chlorite is a byproduct of drinking water disinfected with conventional chlorine or chlorine derivatives. The drinkable water in one or more embodiments of the present invention does not use chlorine or chlorine derivatives for disinfection, and therefore, this byproduct can be essentially non-present, and when accidentally present, is of a neglectable amount indicated above.

The drinkable water produced according to one or more embodiments may refer to a water product in which haloacetic acids (HAA5) are no greater than 0.06 ppm, 0.03 ppm, 0.01 ppm, or 0.005 ppm. HAM is a byproduct of drinking water disinfected with conventional chlorine or chlorine derivatives. The drinkable water in one or more embodiments of the present invention does not use chlorine or chlorine derivatives for disinfection, and therefore, this byproduct can be essentially non-present, and when accidentally present, is of a neglectable amount indicated above.

The drinkable water produced according to one or more embodiments may refer to a water product in which total trihalomethanes (TTHMs) are no greater than 0.08 ppm, 0.06 ppm, 0.04 ppm, 0.02 ppm, or 0.01 ppm. TTHM is a byproduct of drinking water disinfected with conventional chlorine or chlorine derivatives. The drinkable water in one or more embodiments of the present invention does not use chlorine or chlorine derivatives for disinfection, and therefore, this byproduct can be essentially non-present, and when accidentally present, is of a neglectable amount indicated above.

The drinkable water produced according to one or more embodiments may refer to a water product in which chloramines are no greater than 4.0 ppm, 2.0 ppm, 1.0 ppm, 0.05 ppm, or 0.01 ppm. Chloramines are a byproduct of drinking water disinfected with conventional chlorine or chlorine derivatives. The drinkable water in one or more embodiments of the present invention does not use chlorine or chlorine derivatives for disinfection, and therefore, this byproduct can be essentially non-present, and when accidentally present, is of a neglectable amount indicated above.

The drinkable water produced according to one or more embodiments may refer to a water product in which chlorine is no greater than 4.0 ppm, 2.0 ppm, 1.0 ppm, 0.05 ppm, or 0.01 ppm. Chlorine is a byproduct of drinking water disinfected with conventional chlorine or chlorine derivatives. The drinkable water in one or more embodiments of the present invention does not use chlorine or chlorine derivatives for disinfection, and therefore, this byproduct can be essentially non-present, and when accidentally present, is of a neglectable amount indicated above.

The drinkable water produced according to one or more embodiments may refer to a water product in which chlorine dioxide as ClO₂ is no greater than 0.8 ppm, 0.6 ppm, 0.4 ppm, 0.2 ppm, or 0.1 ppm. Chlorine dioxide is a byproduct of drinking water disinfected with conventional chlorine or chlorine derivatives. The drinkable water in one or more embodiments of the present invention does not use chlorine or chlorine derivatives for disinfection, and therefore, this byproduct can be essentially non-present, and when accidentally present, is of a neglectable amount indicated above.

Ag may be included at a concentration of 50 ppt (trillion) to 100 ppb (billion), 250 ppt to 10 ppb, 100 ppt to 10 ppb, or 500 ppt to 2 ppb. In certain instances, Ag is employed at the cathode as the first metal.

Cu may be included at a concentration of no less than 10 ppb, 25 ppb, 50 ppb, 75 ppb, 100 ppb, 125 ppb, 150 ppb, 175 ppb or 200 ppb, and no greater than 2 ppm, 1.5 ppm, 1 ppm, or 500 ppb. In certain instances, Cu may be included at a concentration of 5 ppb to 1 ppm, 10 ppb to 2 ppm, 10 ppb to 250 ppb, 50 ppb to 1.2 ppm, or 200 ppb to 800 ppb. In certain instances, Cu is employed at the anode as the second metal.

Zn may be included at a concentration of no less than 100 ppb, 200 ppb, 300 ppb, 400 ppb, or 500 ppb, and no greater than 20 ppm, 15 ppm, 10 ppm, 5 ppm, or 2 ppm. In certain instances, Zn may be included at a concentration of 100 ppb to 2 ppm, 100 ppb to 20 ppm, 20 ppb to 15 ppm, 500 ppb to 10 ppm, 200 ppb to 5 ppm, or 500 ppb to 2 ppm. In certain instances, Zn is employed at the anode as the second metal.

Embodiments of the present invention have been described with a particular focus on water disinfection. However, it should be appreciated that other types of liquids, including juices, coffee drinks, energy drinks or other drinks for human consumption may be advantageously safeguarded via the residual disinfection method described herein.

Having generally described several embodiments of this invention, a further understanding can be obtained by reference to certain specific examples which are provided herein for purposes of illustration only and are not intended to be limiting unless otherwise specified.

### EXAMPLES

### Experimental Design

The test water used for the examination of the antimicrobial activity of the provided metallic granular media pouches was deionized water with the addition of Dulbecco's phosphate buffered saline (DPBS) at a 1:10 DPBS dilution, to achieve a the salinity of the water that better models real world natural conditions (about 750 mg/L total dissolved solids). The test water was stored at ambient (room) temperature for the duration of the experiment.

Water was spiked with two test microbes (MS2 coliphage and E. coli K011 bacteria) to concentrations of 10⁵/mL, and the microbial concentrations in each container were analyzed periodically over time during storage at ambient temperature. Sampling times were established as 0, 1, 3, 6, 12, 24 and 48 hours of exposure. After each sample was taken, a neutralizing agent were added to chelate any metals present in solution, and samples were immediately assayed or stored by refrigeration until time of assay.

The concentrations of candidate antimicrobial metal ions, specifically zinc, copper, and silver present in the water of containers with pouches were measured for each sampling time. These concentrations were measured by removing aliquots of water inductively coupled plasma mass spectrometry (ICP-MS). Sulfate analysis was also conducted for all water samples.

Data on concentrations of test microbes present at each time interval were analyzed according to standard approaches to determine microbial survival over time, defined as a microbial survival experiment. The spread plate assay with MacConkey agar was used to culture E. coli, and the Single Agar Layer assay on half strength Tryptic Soy Agar (TSA) (with antibiotics and MgCl₂) was used for MS2. Microbial levels in container samples from the different contact times were examined for changes in concentration over time. Calculations of log₁₀ microbe reductions were used to characterize inactivation. These reduction kinetics are expressed as log₁₀ Nt/No values, where No is the microbe concentration at time=0 and Nt is the microbe concentration at time=t. Also calculated were the Nt/Nc values, which describe microbial inactivation achieved from in the water sample of each pouch at a given time point in comparison to the corresponding negative (pouch-free) control concentration, Nc, at that sampling time. Three independent trials of this experiment were conducted, utilizing three replicate sets of 9 granular media pouches with different concentrations of metallic particles.

### Methods and Materials

Quantification of microorganisms may be accomplished through 9221 F Standard Methods for the Examination of Water and Wastewater, 20th Edition 1998, incorporated by reference. EC-MUG (Method 9221 F) or NA-MUG (Method 9222 G) can be used for E. coli testing step as described in 141.21(f)(6)(i) or (iii) after use of Standard Methods 9221 B, 9221 D, 9222 B, or 9222 C.

E. coli strain K011 was grown overnight to stationary phase in tryptic soy broth (TSB) and was pre-titered for viable count by spread plating serial 10-fold dilutions on MacConkey agar to determine stock concentration as colony-forming units. MS2 stock was pre-titered for infectivity on E. coli Famp host using a single agar layer assay with half strength TSA.

After assays of microbial stocks, 40 liters of 1:10 DPBS was supplemented with E. coli KO11 and MS2 to a target concentration of 10⁵-10⁶ microbes/milliliter. The 40 L volumes were mixed and then dispensed as 4 L volumes into 10 separate 4 L containers.

Initial t=0 samples (5 mL) were then taken from each container and supplemented with neutralizing agents, specifically EDTA for copper and zinc and a silver quencher (thioglycolate-thiosulfate). Samples were serially diluted tenfold in 1:10 DPBS, and were then assayed for E. coli and MS2. This provided an initial microbial concentration to which to compare later results.

Further sampling times included 1, 3, 6, 12, 24 and 48 hours after the start of the experiment. For each of these timepoints, 20 mL samples were taken. Each sample was split into 5 mL for microbial assays, 5 mL for ICP-MS analysis, and 10 mL for sulfate analysis. Neutralizing agents were added only to microbial samples, as the silver quencher contained sulfate and would alter sulfate sample readings. Microbial sampling at each timepoint was conducted the same as for the t=0 timepoint.

To measure concentrations of culturable E. coli, 0.1 ml volumes of appropriate 10-fold dilutions of test water were spread plated onto each of 3 MacConkey agar medium plates. The plates were allowed to absorb the sample, and were then inverted and incubated at 35-37° C. overnight. Results were recorded as colony forming units (CFU) and the concentrations of E. coli were calculated as CFU/ml.

MS2 was measured using a single agar layer technique with triplicate 0.1 ml volumes of appropriate dilutions of test water per sample. Each 0.1 ml volume was pipetted onto a 100 mm petri dish. Following this, 10-12 mL of 44° C. half strength TSA supplemented with Streptomycin-ampicilin (antibiotics at 15 mg/L each), MgCl₂ (at 0.04M to improve coliphage detection), and log phase E. coli Famp (bacterial host) and the mixture was swirled in the plate to mix with the sample. The agar layer was allowed to harden and then inverted and incubated overnight at 35-37 degrees C. Results were recorded as plaque forming units (PFU) and the concentrations of MS2 were calculated as PFU/ml.

Sulfate analysis was performed with a LaMotte sulfate kit, which detects 20-200 ppm sulfate in water at 20 mL increments. Lab-made standards were prepared and verified the results of the sulfate kit as accurate.

Test water samples for ICP-MS analysis were taken to a separate core facility laboratory in the Department of Environmental Sciences and Engineering, where they were acidified and refrigerated for storage until analysis.

### Data Analysis Approach

After these experiment procedures were completed, results were recorded as described above and a series of standardization methods were applied to the data to give log reduction values. These standardization methods display disinfection kinetics according to the Chick-Watson Model of first order disinfection kinetics. This method is generally accepted to be the standard in modeling disinfection data collected as a single population of microbes exposed to a disinfectant over a period of contact time with intermittent sampling times.

In this study, three separate trials were performed. Each trial gave data for the 10 containers (9 with metals-containing granular media pouches+1 control with no pouch) at 7 time points.

The first steps performed in the data analysis included sample dilution standardization and combination of replicates per dilution to determine the concentration of microbes in the individual water samples at each time point for each container. This compiled the total CFU's or PFU's recorded for a water sample at countable dilutions and divided that summed count by the total sample volume that the CFU or PFU sum represented, taking sample dilutions into account. Then the replicate results from the dilution standardizations of each given sample were averaged to provide an estimate of the concentration of the microbes. This provided the estimate of CFU or PFU per milliliter in each container at each sampling time point.

After calculating the concentration of microbes in the containers for each timepoint, the next step in data analysis was to perform a time-zero standardization. This was done by dividing each microbial concentration value at a timepoint by the t=0 value for that timepoint, giving a log₁₀ Nt/N0 value corresponding to each timepoint for each container. This normalization helps compare relative changes in microbial survival over time, and was intended to overcome differences in initial microbial concentrations as a barrier to comparisons between containers.

Because microbes can be variable in behavior and resiliency between disinfection experiments, normalization was made to account for potential differences in behavior of the microbes. This was done by subtracting the log₁₀ Nt/N0 value of the control from the log₁₀ Nt/N0 value of each container at each timepoint, to give a log₁₀ Nt/Nc result. Values changes in log₁₀ microbe concentrations for each of the 9 containers with metallic granular media pouches were adjusted to reflect these changes. This control-standardization best describes the changes in concentration of MS2 and E. coli in water that does not have any metallic granular media particles (negative control) versus the waters that have granular media metals-positive pouches at that specific timepoint. Here, a negative log₁₀ value represents microbial reduction relative to the control, whereas positive log₁₀ values indicate microbial growth.

Sulfate analysis was performed on waters of samples at all time points, as well as on samples of water taken from containers 15 minutes and 30 minutes after the start of the experiment. In all cases, the level of sulfate was not detectable by the LaMotte kit, indicating the sulfate level to be <20 ppm in the water throughout all experiments. Lab made standards of 20 ppm and 40 ppm were tested and verified the ability of the kit to provide accurate results.

### Example 1

The following tables represent different metal compositions that were tested for water disinfection efficacy and E. coli and/or MS2 log reduction.

TABLE 4
pouch 1a

| Metal | % of total weight |
|---|---|
| Copper | 87.69% |
| Pure Zinc has a surface area to | 10.92% |
| volume value of 4.5 ± 15% | |
| Silver | 0.87% |
| Copper Sulfate | 0.52% |
| total % and total weight | 100% (28.85 grams) |

TABLE 5
pouch 1b

| Metal | % of total weight |
|---|---|
| Copper | 87.69% |
| Zinc Alloy has surface area to | 10.92% |
| volume value of 4.5 ± 15% | |
| Silver | 0.87% |
| Copper Sulfate | 0.52% |
| total % and total weight | 100% (28.85 grams) |

TABLE 6
pouch 1c

| Metal | % of total weight |
|---|---|
| Copper | 87.69% |
| Zinc Alloy has surface area to | 10.92% |
| volume value of 20.4 ± 15% | |
| Silver | 0.87% |
| Copper Sulfate | 0.52% |
| total % and total weight | 100% (28.85 grams) |

TABLE 7
pouch 2a

| Metal | % of total weight |
|---|---|
| Copper | 78.85% |
| Pure Zinc has a surface area to | 19.76% |
| volume value of 4.5 ± 15% | |
| Silver | 0.87% |
| Copper Sulfate | 0.52% |
| total % and total weight | 100% (28.85 grams) |

TABLE 8
pouch 2b

| Metal | % of total weight |
|---|---|
| Copper | 78.85% |
| Zinc Alloy has surface area to | 19.76% |
| volume value of 4.5 ± 15% | |
| Silver | 0.87% |
| Copper Sulfate | 0.52% |
| total % and total weight | 100% (28.85 grams) |

TABLE 9
pouch 2c

| Metal | % of total weight |
|---|---|
| Copper | 78.85% |
| Zinc Alloy has surface area to | 19.76% |
| volume value of 20.4 ± 15% | |
| Silver | 0.87% |
| Copper Sulfate | 0.52% |
| total % and total weight | 100% (28.85 grams) |

TABLE 10
pouch 3a

| Metal | % of total weight |
|---|---|
| Copper | 49.305% |
| Pure Zinc has a surface area to | 49.305% |
| volume value of 4.5 ± 15% | |
| Silver | 0.87% |
| Copper Sulfate | 0.52% |
| total % and total weight | 100% (28.85 grams) |

TABLE 11
pouch 3b

| Metal | % of total weight |
|---|---|
| Copper | 49.305% |
| Zinc Alloy has surface area to | 49.305% |
| volume value of 4.5 ± 15% | |
| Silver | 0.87% |
| Copper Sulfate | 0.52% |
| total % and total weight | 100% (28.85 grams) |

TABLE 12
pouch 3c

| Metal | % of total weight |
|---|---|
| Copper | 49.305% |
| Zinc Alloy has surface area to | 49.305% |
| volume value of 20.4 ± 15% | |
| Silver | 0.87% |
| Copper Sulfate | 0.52% |
| total % and total weight | 100% (28.85 grams) |

Microbiological results here are organized by trial. Trial 1 corresponds to the first run of the experiment, trial 2 the second, and trial 3 the third. Results presented for each of the trials include the log₁₀ Nt/N0 values and the log₁₀ Nt/Nc values, shown in table and graph forms. In tables, non-detectable levels of microbes are shown as blank cells. On the graphs, values for each time point are marked according to each container, and the right end of a line indicates the last time point with a detectable concentration of a microbe (i.e., the next time point had non-detectable levels of that microbe, and the microbes is assumed to be completely inactivated based on the lower detection limit of the culture assay procedure). Because the waters of all containers with pouches except the waters of the pouch-free controls resulted in inactivation of all detectable microbes by t=48 hours, the graphs only display contact times up to t=24 hours.

Trial 1: E. coli KO11 Log₁₀ Nt/N0 Values in Test Water Samples Over Time

TABLE 13
Trial 1: E. coli KO11 Log₁₀ Nt/N0 Values in Test Water Samples
over Time

| pouch | | | | | | | |
|---|---|---|---|---|---|---|---|
| number | 0 | 1 hr | 3 hrs | 6 hrs | 12 hrs | 24 hrs | 48 hrs |
| 1a | 0 | −0.01 | −0.47 | −3.05 | | | |
| 1b | 0 | −0.01 | −0.44 | −1.82 | −2.60 | | |
| 1c | 0 | −0.08 | −0.48 | −0.99 | −2.12 | −4.90 | |
| 2a | 0 | −0.20 | −0.32 | −0.89 | −1.50 | −4.34 | |
| 2b | 0 | −0.60 | −0.61 | −1.98 | −3.57 | | |
| 2c | 0 | −0.51 | −0.89 | −1.61 | −4.58 | −5.06 | |
| 3a | 0 | −0.08 | −0.21 | −0.94 | −0.88 | −1.96 | |
| 3b | 0 | −0.02 | −0.41 | −1.90 | −3.03 | −4.01 | |
| 3c | 0 | −0.13 | −0.45 | −1.46 | −2.76 | −3.18 | |
| control | 0 | −0.07 | 0.17 | 0.37 | 0.35 | 1.37 | 1.21 |

In trial 1, the log₁₀ Nt/N0 values for changes in E. coli concentration over time show that there is considerable reduction of E. coli over 24 hours in all containers of pouches of granular media with metals present. Vessel 1A shows a 3 log₁₀ reduction after just 6 hours, and complete elimination of detectable E. coli at t=12 hours. Other granular media pouches that appear to be highly antimicrobial include 1B, 2B, and 2C. Note that the log₁₀ Nt/N0 values of the control container appear to increase by almost 1.5 log₁₀ over just 24 hours.

TABLE 14
E. coli KO11 Log₁₀ Nt/Nc Values in Test Water Samples over Time

| pouch | | | | | | |
|---|---|---|---|---|---|---|
| number | 0 | 1 hr | 3 hrs | 6 hrs | 12 hrs | 24 hrs |
| 1a | 0.00 | 0.06 | −0.65 | −3.41 | | |
| 1b | 0.00 | 0.06 | −0.61 | −2.19 | −2.95 | |
| 1c | 0.00 | −0.02 | −0.65 | −1.36 | −2.47 | −6.27 |
| 2a | 0.00 | −0.13 | −0.49 | −1.25 | −1.85 | −5.71 |
| 2b | 0.00 | −0.53 | −0.78 | −2.35 | −3.91 | |
| 2c | 0.00 | −0.44 | −1.06 | −1.97 | −4.93 | −6.43 |
| 3a | 0.00 | −0.01 | −0.39 | −1.31 | −1.23 | −3.32 |
| 3b | 0.00 | 0.05 | −0.59 | −2.27 | −3.37 | −5.37 |
| 3c | 0.00 | −0.07 | −0.63 | −1.83 | −3.11 | −4.54 |

Results for normalized log₁₀ reductions of E. coli shown in Table 14 as values of Log Nt/Nc appear to follow similar trends as the values for log Nt/N0 shown in Table 14. However, in Table 14 there are increased estimates of log₁₀ reductions at t=24 hours, due to the increased concentrations (apparent growth) of E. coli in the control vessel of water lacking a pouch of granular media. By 48 hours log₁₀ E. coli reduction ranges from ≧6.4 to ≧3.3, depending on the pouch of granular media in the test water.

TABLE 15
MS2 Log₁₀ Nt/N0 Values in Test Water Samples over Time

| pouch | | | | | | | |
|---|---|---|---|---|---|---|---|
| number | 0 | 1 hr | 3 hrs | 6 hrs | 12 hrs | 24 hrs | 48 hrs |
| 1a | 0.00 | −0.77 | −0.79 | −2.28 | −4.00 | | |
| 1b | 0.00 | −0.15 | −0.52 | −0.99 | −3.49 | | |
| 1c | 0.00 | −0.41 | −0.48 | −1.24 | −2.35 | −4.16 | |
| 2a | 0.00 | −0.48 | −0.62 | −0.85 | −1.63 | −3.02 | |
| 2b | 0.00 | −0.75 | −0.87 | −1.03 | −3.65 | −4.13 | |
| 2c | 0.00 | −0.68 | −0.77 | −1.10 | −3.41 | −3.71 | |
| 3a | 0.00 | −0.53 | −0.38 | −0.74 | −1.43 | −2.86 | |
| 3b | 0.00 | −0.08 | −0.39 | −0.87 | −2.79 | −3.89 | |
| 3c | 0.00 | −0.23 | −0.23 | −1.47 | −3.05 | −3.73 | |
| control | 0.00 | −0.02 | −0.02 | 0.18 | 0.11 | −0.02 | 0.57 |

As shown in Table 15, the log₁₀ Nt/N0 values for reductions of MS2 bacteriophage in test waters over 24 hours are appreciable for all containers with pouches of granular media with metals present. The relative effectiveness among the granular media pouches appears to be similar for the inactivation of both E. coli and MS2. Vessel 1A shows a 4 log₁₀ reduction of MS2 after 12 hours, and complete elimination of detectable MS2 at t=24 hours. Based on MS2 reductions in test waters with pouches of granular media with metals, other pouches that appear to be the most highly antimicrobial include 1B, 2B, and 2C, as was likewise previously observed for E. coli reductions.

TABLE 16
Trial 1: MS2 Log10 Nt/Nc Values in Test Water Samples over Time

| pouch | | | | | | |
|---|---|---|---|---|---|---|
| number | 0 | 1 hr | 3 hrs | 6 hrs | 12 hrs | 24 hrs |
| 1a | 0.00 | −0.76 | −0.78 | −2.46 | −4.11 | |
| 1b | 0.00 | −0.14 | −0.50 | −1.18 | −3.60 | |
| 1c | 0.00 | −0.39 | −0.46 | −1.42 | −2.46 | −4.14 |
| 2a | 0.00 | −0.47 | −0.60 | −1.03 | −1.74 | −3.01 |
| 2b | 0.00 | −0.73 | −0.85 | −1.21 | −3.76 | −4.12 |
| 2c | 0.00 | −0.67 | −0.75 | −1.28 | −3.51 | −3.69 |
| 3a | 0.00 | −0.51 | −0.36 | −0.92 | −1.54 | −2.84 |
| 3b | 0.00 | −0.06 | −0.37 | −1.05 | −2.89 | −3.88 |
| 3c | 0.00 | −0.21 | −0.21 | −1.65 | −3.16 | −3.72 |

As shown in Tables 15 and 16, the log Nt/Nc values appear to correlate well with the log Nt/N0 values. This is to be expected as the control values of log Nt/N0 stay fairly stable throughout the time period of the experiment. Therefore, these two measures of log₁₀ reduction, log₁₀ Nt/No and log₁₀ Nc/No, provide similar information for interpretation. The patterns of log₁₀ reductions are similar and show that MS2 reductions in test waters by 24 hours range from about 2.8 to 4.1 log₁₀ depending on which pouch of granular medium with metals is in the test water. In all but one case, pouches of granular media with metals achieved log₁₀ reductions of MS2 that were 3 or greater by 24 hours.

### Trial 2:

TABLE 17
Trial 2: E. coli Log₁₀ Nt/N0 Values in Test Water Samples over Time

| pouch | | | | | | | |
|---|---|---|---|---|---|---|---|
| number | 0 | 1 hr | 3 hrs | 6 hrs | 12 hrs | 24 hrs | 48 hrs |
| 1a | 0.00 | −0.05 | −0.30 | −0.82 | −3.24 | | |
| 1b | 0.00 | −0.15 | −0.32 | −0.64 | −1.92 | −5.27 | |
| 1c | 0.00 | −0.04 | −0.12 | −0.61 | −1.64 | −3.33 | |
| 2a | 0.00 | −0.05 | −0.16 | −0.41 | −1.70 | | |
| 2b | 0.00 | 0.02 | −0.13 | −0.50 | −1.52 | −4.50 | |
| 2c | 0.00 | −0.07 | −0.23 | −0.53 | −1.87 | −2.78 | |
| 3a | 0.00 | −0.06 | −0.33 | −0.39 | −1.41 | −2.40 | |
| 3b | 0.00 | −0.08 | −0.26 | −0.44 | −1.40 | −3.69 | |
| 3c | 0.00 | −0.08 | −0.24 | −0.60 | −1.39 | −2.37 | |
| control | 0.00 | −0.04 | −0.05 | 0.00 | −0.01 | −0.06 | 0.13 |

As Shown in Table 17, log₁₀ Nt/N0 reductions of E. coli in test waters with granular media pouches with metals for this trial appear to be slower than for trial 1. However, appreciable reductions of >2 log₁₀ and as much as >5 log₁₀ are still achieved for all test waters with metal-containing granular media pouches over the time period of 24 hours. Log₁₀ reductions were >3 by 24 hours in six of the nine test water samples with metal-containing granular media pouches. Vessel 1A appears to have the pouch of granular media with metals that inactivate the E. coli the fastest, with a 3 log₁₀ reduction by 12 hours, and complete inactivation of detectable bacteria by t=24 hours. Pouches 1B and 2B also show appreciable inactivation over the 24 hour time period.

TABLE 18
Trial 2: E. coli Log₁₀ Nt/Nc Values in Test Water Samples over Time

| pouch | | | | | | |
|---|---|---|---|---|---|---|
| number | 0 | 1 hr | 3 hrs | 6 hrs | 12 hrs | 24 hrs |
| 1a | 0.00 | −0.01 | −0.26 | −0.82 | −3.23 | |
| 1b | 0.00 | −0.12 | −0.28 | −0.63 | −1.91 | −5.21 |
| 1c | 0.00 | 0.00 | −0.07 | −0.61 | −1.63 | −3.28 |
| 2a | 0.00 | −0.01 | −0.11 | −0.41 | −1.70 | |
| 2b | 0.00 | 0.06 | −0.08 | −0.50 | −1.52 | −4.44 |
| 2c | 0.00 | −0.03 | −0.19 | −0.52 | −1.87 | −2.72 |
| 3a | 0.00 | −0.02 | −0.29 | −0.39 | −1.40 | −2.35 |
| 3b | 0.00 | −0.04 | −0.22 | −0.44 | −1.40 | −3.63 |
| 3c | 0.00 | −0.04 | −0.20 | −0.60 | −1.38 | −2.31 |

As shown in Table 18, the E. coli log₁₀ Nt/Nc reduction values of this experiment are almost exactly the same as the log 10 Nt/N0 reduction values for this trial. This is because the E. coli concentration of the control vessel remains essentially the same throughout the time period of the experiment.

TABLE 19
Trial 2: MS2 Log₁₀ Nt/N0 Values in Test Water Samples over Time

| pouch | | | | | | |
|---|---|---|---|---|---|---|
| number | 0 | 1 hr | 3 hrs | 6 hrs | 12 hrs | 24 hrs |
| 1a | 0.00 | −0.10 | −0.30 | −1.03 | −3.06 | |
| 1b | 0.00 | −0.08 | −0.43 | −1.02 | −2.96 | |
| 1c | 0.00 | −0.10 | −0.36 | −0.81 | −1.76 | |
| 2a | 0.00 | −0.04 | −0.31 | −0.75 | −1.88 | |
| 2b | 0.00 | −0.03 | −0.32 | −0.85 | −2.00 | −4.75 |
| 2c | 0.00 | −0.14 | −0.36 | −0.87 | −1.76 | |
| 3a | 0.00 | −0.11 | −0.28 | −0.57 | −1.45 | |
| 3b | 0.00 | −0.09 | −0.41 | −1.01 | −2.68 | |
| 3c | 0.00 | −0.18 | −0.54 | −0.89 | −2.80 | −5.07 |

As shown in Table 19, the log 10 Nt/N0 reduction values for MS2 in this trial, are extensive in all of the of the metals-containing granular media tested, with >4.7 log₁₀ Nt/No reductions by 24 hours. Vessels 1A and 1B show the fastest reductions, with 3 log₁₀ reductions by 12 hours, and complete elimination of detectable MS2 bacteriophage by t=24 hours.

TABLE 20
Trial 2: MS2 Log₁₀ Nt/Nc Values in Test Water Samples over Time

| pouch | | | | | | |
|---|---|---|---|---|---|---|
| number | 0 | 1 hr | 3 hrs | 6 hrs | 12 hrs | 24 hrs |
| 1a | 0.00 | −0.10 | −0.28 | −1.04 | −3.09 | |
| 1b | 0.00 | −0.07 | −0.41 | −1.04 | −2.99 | |
| 1c | 0.00 | −0.10 | −0.34 | −0.83 | −1.79 | |
| 2a | 0.00 | −0.04 | −0.29 | −0.77 | −1.91 | |
| 2b | 0.00 | −0.02 | −0.30 | −0.87 | −2.03 | −4.79 |
| 2c | 0.00 | −0.13 | −0.34 | −0.89 | −1.79 | |
| 3a | 0.00 | −0.11 | −0.26 | −0.59 | −1.48 | |
| 3b | 0.00 | −0.08 | −0.39 | −1.03 | −2.71 | |
| 3c | 0.00 | −0.18 | −0.52 | −0.91 | −2.83 | −5.11 |

As shown in Table 20 the log 10 Nt/Nc values for MS2 reduction are very similar to the log₁₀ Nt/N0 values. This is because the control vessel lacking a pouch of metals-containing granular media had log Nt/N0 values that remained approximately the same throughout the time period of the experiment.

### Trial 3:

TABLE 21
Trial 3: E. coli Log₁₀ Nt/N0 Values in Test Water Samples over Time

| pouch | | | | | | | |
|---|---|---|---|---|---|---|---|
| number | 0 | 1 hr | 3 hrs | 6 hrs | 12 hrs | 24 hrs | 48 hrs |
| 1a | 0.00 | −0.08 | −0.55 | −3.01 | | | |
| 1b | 0.00 | −0.03 | −0.53 | −1.56 | −2.01 | | |
| 1c | 0.00 | −0.05 | −0.45 | −1.58 | −2.71 | −4.25 | |
| 2a | 0.00 | −0.02 | −0.64 | −1.62 | −2.67 | | |
| 2b | 0.00 | −0.05 | −0.67 | −2.28 | −3.78 | | |
| 2c | 0.00 | −0.11 | −0.81 | −2.16 | −3.92 | | |
| 3a | 0.00 | −0.05 | −0.76 | −2.31 | −2.74 | −4.23 | |
| 3b | 0.00 | −0.10 | −0.54 | −1.61 | −3.15 | −5.41 | |
| 3c | 0.00 | −0.07 | −0.48 | −1.62 | −3.22 | | |
| control | 0.00 | −0.02 | −0.04 | 0.00 | 0.17 | 0.31 | 0.44 |

As shown in Table 21, The log 10 Nt/N0 values for E. coli for trial 3 appear to follow a similar trend as the values for trial 1. Log₁₀ E. coli reductions were rapid and extensive, with 2 or more log₁₀ reduction by 12 hours and >4.2 log₁₀ reduction by 24 hours in test waters of all pouches of metals-containing granular media tested. The metals-containing granular media pouch of Vessel 1A appears to be the most antimicrobial, with a 3 log₁₀ reduction in test water after 6 hours, and complete inactivation of detectable bacteria in test water by t=12 hours. Also strongly antimicrobial are metals-containing granular media pouches 2B and 2C, which show 4 log₁₀ reductions at t=12 hours, and complete elimination at t=24 hours. The E. coli concentration of the control container lacking a granular media pouch appears to increase almost 0.5 log₁₀ over the course of the experimental time period.

TABLE 22
Trial 3: E. coli Log₁₀ Nt/Nc Values in Test Water Samples over Time

| pouch | | | | | | |
|---|---|---|---|---|---|---|
| number | 0 | 1 hr | 3 hrs | 6 hrs | 12 hrs | 24 hrs |
| 1a | 0.00 | −0.05 | −0.52 | −3.01 | | |
| 1b | 0.00 | 0.00 | −0.49 | −1.56 | −2.18 | |
| 1c | 0.00 | −0.02 | −0.41 | −1.58 | −2.87 | −4.56 |
| 2a | 0.00 | 0.00 | −0.60 | −1.62 | −2.83 | |
| 2b | 0.00 | −0.02 | −0.63 | −2.28 | −3.95 | |
| 2c | 0.00 | −0.08 | −0.78 | −2.15 | −4.09 | |
| 3a | 0.00 | −0.02 | −0.72 | −2.30 | −2.91 | −4.54 |
| 3b | 0.00 | −0.07 | −0.51 | −1.61 | −3.32 | −5.72 |
| 3c | 0.00 | −0.04 | −0.44 | −1.62 | −3.39 | |

As shown in Table 22, the log Nt/Nc reduction values of E. coli in test waters with metals-containing granular media pouches are similar to the log Nt/N0 reduction values for this trial up to t=12 hours. However, at t=24 hours, the log₁₀ Nt/No values of the control vessel shows an increase of 0.3 log₁₀. Therefore, in the other vessels of water with metals-containing granular media pouches that had detectable levels of E. coli at this time point, the log₁₀ reductions increased by 0.3 logs, with all reductions at least 4.5 log₁₀.

TABLE 23
Trial 3: MS2 Log₁₀ Nt/N0 Values in Test Water Samples over Time

| pouch | | | | | | | |
|---|---|---|---|---|---|---|---|
| number | 0 | 1 hr | 3 hrs | 6 hrs | 12 hrs | 24 hrs | 48 hrs |
| 1a | 0.00 | −0.05 | −0.41 | −2.43 | | | |
| 1b | 0.00 | −0.04 | −0.53 | −1.69 | | | |
| 1c | 0.00 | −0.03 | −0.43 | −1.27 | −3.24 | | |
| 2a | 0.00 | −0.01 | −0.36 | −1.17 | −3.02 | | |
| 2b | 0.00 | −0.04 | −0.79 | −2.76 | | | |
| 2c | 0.00 | −0.06 | −0.59 | −2.55 | | | |
| 3a | 0.00 | −0.04 | −0.56 | −1.24 | −3.26 | | |
| 3b | 0.00 | −0.10 | −0.35 | −1.32 | −3.04 | −4.86 | |
| 3c | 0.00 | −0.04 | −0.53 | −2.39 | −3.46 | | |
| control | 0.00 | −0.03 | −0.03 | −0.13 | −0.16 | −0.12 | −0.08 |

As shown in Table 23, the log₁₀ Nt/N0 reduction values for MS2 in test waters with metals-containing granular media pouches in trial 3 again confirm that all pouches have extensive antimicrobial properties. MS2 log₁₀ Nt/No reductions were 3.0 or more by 12 hours and >4.8 log₁₀ by 24 hours. Vessels with granular media pouches 1A, 2B, and 2C appear to achieve the fastest reductions, with almost a 3 log₁₀ reduction of MS2 after 6 hours, and complete inactivation of detectable MS2 at t=12 hours. The vessel with pouch 1B also appears to be strongly antimicrobial, with almost a 2 log₁₀ reduction of MS2 after 6 hours and undetectable levels of MS2 at t=12 hours.

TABLE 24
Trial 3: MS2 Log₁₀ Nt/Nc Values in Test Water Samples over Time

| pouch | | | | | | |
|---|---|---|---|---|---|---|
| number | 0 | 1 hr | 3 hrs | 6 hrs | 12 hrs | 24 hrs |
| 1a | 0.00 | −0.02 | −0.38 | −2.30 | | |
| 1b | 0.00 | 0.00 | −0.49 | −1.55 | | |
| 1c | 0.00 | 0.01 | −0.40 | −1.13 | −3.08 | |
| 2a | 0.00 | 0.02 | −0.33 | −1.03 | −2.86 | |
| 2b | 0.00 | 0.00 | −0.75 | −2.63 | | |
| 2c | 0.00 | −0.03 | −0.56 | −2.41 | | |
| 3a | 0.00 | 0.00 | −0.53 | −1.10 | −3.10 | |
| 3b | 0.00 | −0.06 | −0.32 | −1.18 | −2.89 | −4.73 |
| 3c | 0.00 | −0.01 | −0.49 | −2.26 | −3.30 | |

The log₁₀ Nt/Nc reduction values for MS2 in test waters containing the various granular media pouches are similar to those for the log₁₀ Nt/No reduction values and therefore can be similarly interpreted for magnitude of antimicrobial effects. This is because the control vessel showed little to no change in MS2 concentration throughout the experimental time period, and therefore did not appreciably affect the estimated log₁₀ reduction values.

Results from all three trials indicate that each of the metal pouches has appreciable antimicrobial properties when placed in 4-liter volumes of buffered test water containing added E. coli and MS2. However, certain granular media metal pouches appeared to have stronger antimicrobial activities than others. Pouch 1A appeared to be the strongest disinfecting agent, achieving ≧3 log₁₀ reduction of E. coli and MS2 in 6 hours for some trials, and in ≦12 hours for all trials. Other candidate granular media pouches that achieved very high antimicrobial activity included pouches 2B, 2C, and 1B.

There appeared to be differences in disinfection efficacy among the 3 trials, particularly in the extent of inactivation of E. coli. Our proposed reason for this apparent difference in antimicrobial effect involves the growth stage of the E. coli used, specifically whether the bacteria were still partially in log phase versus in stationary phase. It appears there were greater and more rapid E. coli reductions in trials 1 and 3 than in trail 2. In these two trials the control vessel E. coli concentration increased by 1.4 and 0.4 log₁₀ over 48 hours for trial 1 and 3, respectively. In trial 2 the control vessel E. coli concentration remained the same throughout the experimental time period. There is the possibility that the E. coli grown for use in trials 1 and 3 were still in log phase, or at least not completely transitioned to stationary phase. The E. coli bacteria grown overnight for trials 1 and 3 had only been grown for 11 and 15 hours (respectively), whereas the E. coli in trial 2 was grown a full 24 hours and was likely in late stationary phase. If this suggested difference in E. coli growth phase is the case, it helps explain the increased log₁₀ E. coli reductions observed in trials 1 and 3, because log phase bacteria cells have been observed to be less resistant to disinfection than stationary phase cells. This difference in the growth phase of the cells also makes possible a quantitative comparison between the disinfection kinetics of log phase and stationary phase.

The World Health Organization specified that POU treatment technologies should achieve ≧2 log₁₀ reduction for bacteria and ≧3 log₁₀ reduction for viruses to be considered ‘protective’ in their performance. In each of these trials, all of the granular media pouches successfully eliminated all of the spiked microbes to below detection limits (corresponding to at least >4 or >5 log₁₀ reduction) before the 48 hour time point; therefore meeting the WHO protective category of disinfection. In some cases, as noted above, granular media pouches 1A, 1B, 2B, and 2C were the most effective in eliminating microbes. However, based on the results of these studies, it appears that all of the combinations of granular media with metals examined met the WHO protective category of performance.

### Example 2

Residual disinfection trials have been run on sample water with metal ion content versus a deionized water control. Prior to contaminant dosing, each water sample contains less than 1 CFU per 100 ml of total coliform, fecal or E. coli coliform and is considered drinkable for human consumption. Each sample along with the deionized control is then dosed with an equivalent quantity of contaminated water containing E. coli and other coliforms. The dosed samples are measured at time zero, which is immediately after dosing, again at 3 hours, 6 hours, 24, 27, 48 and 51 hours.

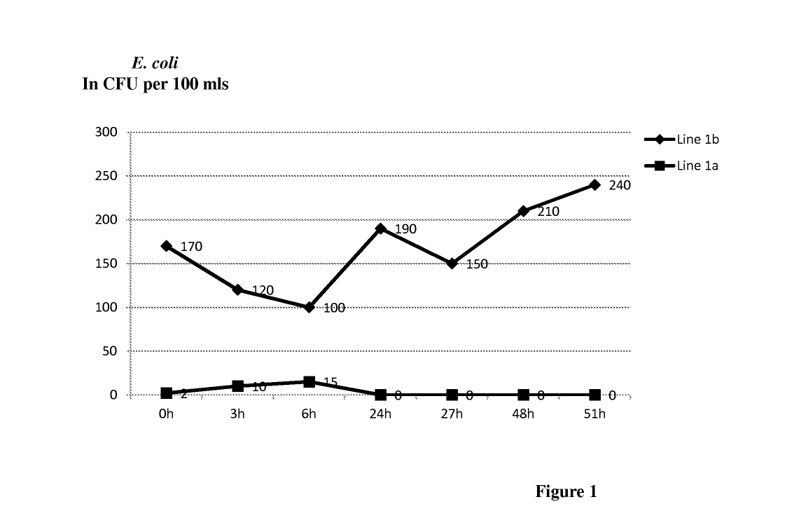

As depicted via line 1a of FIG. 1, total E. coli reading in the sample water stays at or below the 15 CFU per 100 mls mark post-dosing through the entire monitored course of 51 hours. In direct comparison, the control water as depicted via line 1b has a total E. coli reading of from 100 to 240 CFU per 100 mls.

### Example 3

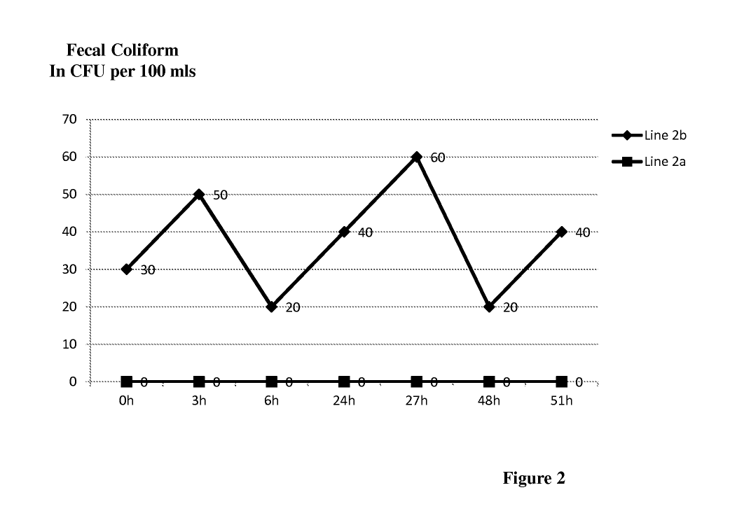

As depicted via line 2a of FIG. 2, fecal coliform reading in the sample water stays non-measurable and well below the 10 CFU per 100 mls mark post-dosing through the entire monitored course of 51 hours. In direction comparison, the control water as depicted via line 2b has a fecal coliform reading of from 20 to 60 CFU per 100 mls.

### Example 4

As depicted in Tables 25 and 26, a metal mixture of 28.85 total grams having 87.69% Cu, 10.92% Pure Zn, 0.87% Ag and 0.52% CuSO₄ was seeded into a water volume of 4 liters. The water volume was seeded with E. coli and MS2 virus. The E. coli and MS2 levels were determined prior to the introduction of the metal mixture.

TABLE 25

| time | bacteria: E. coli, | virus: MS2, |
|---|---|---|
| (hours) | log reduction | log reduction |
| 0 | 0 | 0 |
| 1 | 0 | 0.76 |
| 3 | 0.65 | 0.78 |
| 6 | 3.41 | 2.46 |
| 12 | | 4.11 |

TABLE 26

| time | bacteria: E. coli, | virus: MS2, |
|---|---|---|
| (hours) | log reduction | log reduction |
| 0 | 0 | 0 |
| 1 | 0.01 | 0.1 |
| 3 | 0.26 | 0.28 |
| 6 | 0.82 | 1.04 |
| 12 | 3.23 | 3.09 |

### Example 5

A metal mixture of 28.85 total grams having 87.69% Cu, 10.92% Pure Zn, 0.87% Ag and 0.52% CuSO₄ was seeded into a water volume of 4 liters.

TABLE 27
E. coli Counts

| Time | Control Water | Treated Water | |
|---|---|---|---|
| (hours) | (cfu/100 mL) | (cfu/100 mL) | LRV |
| 1 | 45000 | 10000 | 0.653213 |
| 3 | | 5000 | 0.954243 |
| 6 | | 7000 | 0.808114 |
| 12 | | 600 | 1.875061 |
| 24 | | 70 | 2.808114 |
| 48 | | 1 | 4.653213 |

### Example 6

A metal mixture of 28.85 total grams having 87.69% Cu, 10.92% Pure Zn, 0.87% Ag and 0.52% CuSO₄ was seeded into a water volume of 18.93 liters.

TABLE 28
E. coli Counts

| Time | Control Water | Treated Water | |
|---|---|---|---|
| (hours) | (cfu/100 mL) | (cfu/100 mL) | LRV |
| 0 | 20000 | 5000 | 0.60206 |
| 1 | 16000 | 3000 | 0.726999 |
| 3 | 18000 | 500 | 1.556303 |
| 6 | 18000 | 250 | 1.857332 |
| 12 | 24000 | 100 | 2.380211 |
| 24 | 30000 | 20 | 3.176091 |

### Example 7

A metal mixture of 28.85 total grams having 87.69% Cu, 10.92% Pure Zn, 0.87% Ag and 0.52% CuSO₄ was seeded into a water volume of 189.3 liters.

TABLE 29
E. coli Counts

| Time | Control Water | Treated Water | |
|---|---|---|---|
| (hours) | (cfu/100 mL) | (cfu/100 mL) | LRV |
| 0 | 2200 | 4 | 2.740363 |
| 1 | 2600 | 4 | 2.812913 |
| 3 | 2400 | 4 | 2.778151 |
| 6 | 2600 | 4 | 2.812913 |

While the best mode for carrying out the invention has been described in detail, those familiar with the art to which this invention relates will recognize various alternative designs and embodiments for practicing the invention as defined by the following claims.

1.-39. (canceled)

40. Water disinfecting system usable with an isolated water volume comprising:
a water permeable container; and
a mixture of metals disposed within the container, the mixture of metals comprising a first concentration of a first metal and a second concentration of a second metal, the second metal being different from the first metal, the first and second metals each having an anodic index, the first metal having a higher anodic index than the second metal anodic index, wherein the first metal and second metal form a galvanic coupling when placed into an isolated water volume.

41. The water disinfecting system of claim 13, further comprising a third metal which is different from the first metal and the second metal.

42. The water disinfecting system of claim 14, wherein the first metal, the second metal and third metal are each independently selected from the group consisting of Titanium to Copper to Zinc, Stainless Steel to Copper to Zinc, Titanium to Bronze to Zinc, Stainless Steel to Bronze to Zinc, Titanium to Brass to Zinc, Stainless Steel to Brass to Zinc, Titanium to Copper to Aluminum, Stainless Steel to Copper to Aluminum, Titanium to Bronze to Aluminum, Stainless Steel to Bronze to Aluminum, Titanium to Brass to Aluminum, and Stainless Steel to Brass to Aluminum.

43. The water disinfecting system of claim 15, wherein the copper is substituted with bronze or brass.

44. The water disinfecting system of claim 13, wherein the container contains less than 5% organic matter of a total dry weight of the container.

45. The water disinfecting system of claim 13, wherein the mixture of metals comprises Cu 78-90% by weight, Zn 8-20% by weight, Ag 0-1% by weight, and Cu sulfate 0-1% by weight.

46. The water disinfecting system of claim 13, wherein the mixture of metals comprises Cu 49-51% by weight, Zn 49-51% by weight, Ag 0-1% by weight, and Cu sulfate 0-1% by weight.

47. The water disinfecting system of claim 13, wherein the first metal and second metal have a total weight of up to 1,000 grams.

48. The water disinfecting system of claim 13, wherein the container further comprises limestone, iron oxide, and/or bone char at 0.1 to 50% of a combined weight of the first and second metals.
